(19) United States
(12) Patent Application Publication
(10) Pub. No.: US 2004/0208394 A1
(43) Pub. Date: Oct. 21, 2004

(54) Image display device and method for preventing image Blurring

(75) Inventor: Tohru Kurata, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/820,701

(22) Filed: Apr. 9, 2004

(30) Foreign Application Priority Data
Apr. 16, 2003 (JP) 2003-112006

(51) Int. Cl. G06K 9/40

(52) U.S. Cl. 382/275; 382/260

(57) ABSTRACT

An image display device alleviates image blurring when the relative positional relationship between the image display device and the user's face changes, and also prevents stealthy viewing of information by viewing from directly behind in a train or similar, without being accompanied by the trouble of filter attachment or removal or degraded image quality such as when using a privacy filter. The image display device includes image pick-up unit 3, image display unit 8, detection unit 24 to detect the position of the user's eyes by image recognition from an image picked-up by the image pick-up unit 3, and display position alteration unit 26 to alter the position of image display by the image display unit 8 based on the detection result of the detection unit 24.

### BACKGROUND OF THE INVENTION

1. Field of the Invention

This invention relates to an image display device and a method for preventing image blurring, and in particular relates to a device and a method suitable for being applied to a portable terminal presumed to be used while in motion.

2. Description of the Related Art

Lately, as portable terminals presumed to be used while in motion, mobile phone units, PDAs, portable personal computers, and portable game equipment comprising high-resolution image display devices, have been coming into widespread use. Such devices are used most frequently while riding in trains, automobiles, or other conveyances.

However, if such devices are used within moving conveyances, displayed images appear to be blurred due to oscillations of the conveyance itself, and consequently there is the problem that it is difficult to focus on images displaying detailed information.

The problem is not limited merely to difficulty in viewing image information; ocular fatigue and stress are induced, and in some cases motion sickness may result, and for these reasons this issue has been regarded as a problem for some time.

As techniques of the prior art to alleviate image blurring of image display devices, for example, a method has been proposed in which oscillation detection means such as an angular velocity sensor are used to detect oscillations of the image display device unit, image position correction amounts are calculated using the detection results, and values resulting from the addition of these image position correction amounts to the coordinates of the original image are sent, as the image signal, to an image display portion such as a liquid crystal display device (see for example Japanese Laid-open Patent Application No. 2002-123242, paragraphs 0014 to 0016, FIG. 3, and FIG. 4).

On the other hand, when attempting to utilize a portable terminal within a train or similar, there is the problem that strangers may see the screen and stealthily view information. In the prior art, as a means for alleviating this problem, a privacy filter which narrows the angular range over which the screen is visible has been proposed.

However, in the method described in the above Japanese Laid-open Patent Application, the screen display position is corrected based on the result of detection of oscillation of the image display device unit, so that image blurring as seen by the user is alleviated when the relative positional relationship between the image display device and the eyes of the user does not change (when the manner of swaying of the user's head and the manner of swaying of the image display device coincide perfectly), but when the relative positional relationship between the image display device and the eyes of the user changes (when the manner of swaying of the user's head and the manner of swaying of the image display device do not coincide perfectly), image blurring as seen by the user is not alleviated.

In addition, because when practically holding a portable telephone or similar in the hand while inside a moving conveyance and viewing the screen the swaying of the hand and the swaying of the head due to the oscillations of the conveyance do not coincide (the hand may not sway while the head sways, or the hand and head may sway in different directions), there are frequent changes in the relative positional relationship between the image display device and the user's eyes.

Hence the method described in the above Japanese Laid-open Patent Application cannot adequately alleviate blurring of the image displayed on a portable telephone or similar within a moving conveyance.

On the other hand, the use of a privacy filter so as to alleviate the problem of viewing of the screen by strangers is accompanied by degradation of image quality and the trouble of attaching and removing the filter, as well as the disadvantage that the stealthy viewing of information cannot be prevented when viewed from directly behind the user.

In light of the above problems, this invention was devised for providing an image display device and image blurring prevention method which can alleviate image blurring when there are changes in the relative positional relationship between the image display device and the eyes of the user, and in addition can prevent the stealthy viewing of information by viewing from directly behind the user in a train or similar, without the degradation of image quality or trouble of attachment and removal accompanying the use of a privacy filter.

### SUMMARY OF THE INVENTION

In order to attain the above, the applicant of the present invention proposes an image display device comprising image pick-up means, image display means, detection means to detect the position of the eyes of a face through image recognition from an image acquired by the image pick-up means, and display position alteration means to alter the position of display of an image by the image display means, based on the detection result of the detection means.

In this image display device, the position of the eyes of a face is detected by image recognition from an image picked-up by the image pick-up means included in the image display device. Further, based on the detection result, the position of display of an image by the image display means is altered.

Hence, because the user's own face is picked-up by the image pick-up means, the position of the eyes of the user relative to the image display device (that is, the relative positional relationship of the image display device and the eyes of the user) is detected, and based on this detection result, the display position of the image is altered.

In this way, the display position of an image is altered based on the result of detection of the relative positional relationship of the image display device and the eyes of the user, so that even when the relative positional relationship of the image display device and the user's eyes changes, image blurring as seen by the user can be alleviated.

Further, even when a person other than the user views the screen of the image display device from directly behind within a train, so long as the manner of swaying of the head of the stranger does not perfectly coincide with the manner of swaying of the head of the user (so long as the relative positional relationship between the image display device and the eyes of the stranger does not completely coincide with the relative positional relationship between the image display device and the eyes of the user), the displayed image as seen by the stranger appears blurred, so that stealthy viewing of information can be prevented.

In recent years, it has become common for portable terminals which presume use while in motion to have cameras mounted; hence through application to such portable terminals, the uses and opportunities for use of the camera can be increased, and the camera can be utilized efficiently.

In this image display device, the display position alteration means may for example be realized by a digital interpolation filter which causes parallel movement of the display position of an image in sub-pixel units.

When realizing the image display device using a digital interpolation filter, it is suitable to have the digital interpolation filter estimate and calculate the amount of parallel movement of the display position of the image at the time in the future equal to the delay time arising from processing by the digital interpolation filter.

In this way, by calculating the amount of parallel movement of the image display position at the point in time equal to the delay time due to the digital interpolation filter (that is, the point in time at which the image is actually displayed on the image display device), image blurring can be further alleviated.

Further, when the image display device is realized using a digital interpolation filter, it is suitable that the image display device further comprise distance measurement means to measure the distance to an external object, and that the digital interpolation filter be caused to perform enlargement/reduction processing of the image based on the measurement result of the distance measurement means.

As a result, by measuring the distance from the image display device to the user's own face using this distance measurement means, the user can enlarge and display the image when the distance from the image display device to the user's own face is increased (when the user's head sways backward), and can reduce and display the image when the distance from the image display device to the user's own face is reduced (when the user's head sways forward). Hence even if the distance from the image display device to the user's own face changes, the user can always view an image of the same size.

Further, in this image display device the display position alteration means may be realized by a control device which physically moves the image display means.

Furthermore, it is suitable that this image display device further comprise acceleration measurement means to measure the acceleration of the image display device unit, and that the display position alteration means be caused to alter the image position displayed by the image display means based on the result of detection by the detection means and the result of measurement by this acceleration measurement means.

The acceleration measurement means has fast response and high measurement precision, so that by combining the measurement result of the acceleration (oscillation) of the image display device unit using the acceleration measurement means to alter the image display position, image blurring can be alleviated still further.

Further, it is suitable that this image display device use a CMOS sensor as the image pick-up means.

A CMOS sensor can perform block reading to read arbitrary areas, and so by detecting the position of the eyes of a face using image recognition by the detection means of an image which has been block-read by the CMOS sensor, the position of the eyes of a face can be detected with a high frame rate.

Next, the applicant of the present invention proposes, for use in an image display device having image pick-up means and image display means, a method for preventing the blurring of an image displayed by the image display means, comprising: a first step in which the position of the eyes of a face is detected by image recognition from an image picked-up by the image pick-up means, and a step of altering the position of display of the image by the image display means based on the detection result of the first step.

In this image blurring prevention method, the position of the eyes of a face is detected by image recognition from an image picked-up by image pick-up means included in the image display device. Then, based on the detection results, the position of display of an image by the image display means is altered.

Hence, because the user's own face is picked-up by the image pick-up means, the position of the eyes of the user relative to the image display device (that is, the relative positional relationship between the image display device and the eyes of the user) is detected, and based on this detection result, the position of image display is altered.

In this way, the position of display of an image is altered based on the result of detection of the relative positional relationship between the image display device and the user's eyes, so that even if there are changes in the relative positional relationship of the image display device and the user's eyes, image blurring as seen by the user can be alleviated.

Further, even when the screen of the image display device is viewed by a stranger other than the user from directly behind within a train or similar, so long as the manner of swaying of the head of the stranger and the manner of swaying of the head of the user do not perfectly coincide (so long as the relative positional relationship between the image display device and the stranger's eyes does not perfectly coincide with the relative positional relationship between the image display device and the user's eyes), the image display as seen by the stranger is blurred, so that stealthy viewing of information can be prevented.

In recent years, it has become common for portable terminals, which presume use while in motion, to have cameras mounted; hence through application to such portable terminals, the uses and opportunities for use of the camera can be increased, and the camera can be utilized efficiently.

### BRIEF DESCRIPTION OF THE DRAWINGS

FIG. 1 is a perspective view showing an example of the external appearance of a portable terminal to which this invention is applied;

FIG. 2 is a view showing an image of a user picked-up by the camera of a portable terminal;

FIG. 3 is a view showing an example of physical parallel movement of the image display position;

FIG. 4 is a block diagram showing the circuit configuration of a conventional portable terminal;

FIG. 5 is a block diagram showing an example of the circuit configuration of a portable terminal of this invention;

FIG. 6 is a block diagram showing an example of the circuit configuration of a portable terminal of this invention;

FIG. 7 is a block diagram showing an example of the circuit configuration of a portable terminal of this invention;

FIG. 8 is a view showing an example of cell lighting when displaying an oblique line using a conventional method in a fixed-pixel display device;

FIG. 9 is a view showing an example of cell lighting when displaying an oblique line using ClearType technology in a fixed-pixel display device;

FIG. 10 is a view showing a template image; and,

FIG. 11 is a view showing results of measurement of iris movement amounts, and the time for which parallel movement amounts of the display image are to be estimated.

### DESCRIPTION OF THE PREFERRED EMBODIMENTS

Hereinafter, the present invention will specifically be explained referring to the drawings. This invention may be applied to a portable terminal 1 such as that shown in FIG. 1, having an image display screen 2 and camera 3. Here “portable terminal” refers to compact equipment in general presumed to be used while in motion, and comprises not only portable telephones and PDAs, but mobile-type personal computers (notebook personal computers and similar) and portable game equipment as well.

In this invention, the positions of the eyes and irises of the user are recognized and their movement is tracked by the camera 3 of such portable terminal 1, to observe fluctuations in the relative positions of the portable terminal 1 and the user; and the image displayed on the image display screen 2 of the portable terminal 1 is to undergo parallel movement such that the fluctuations are cancelled.

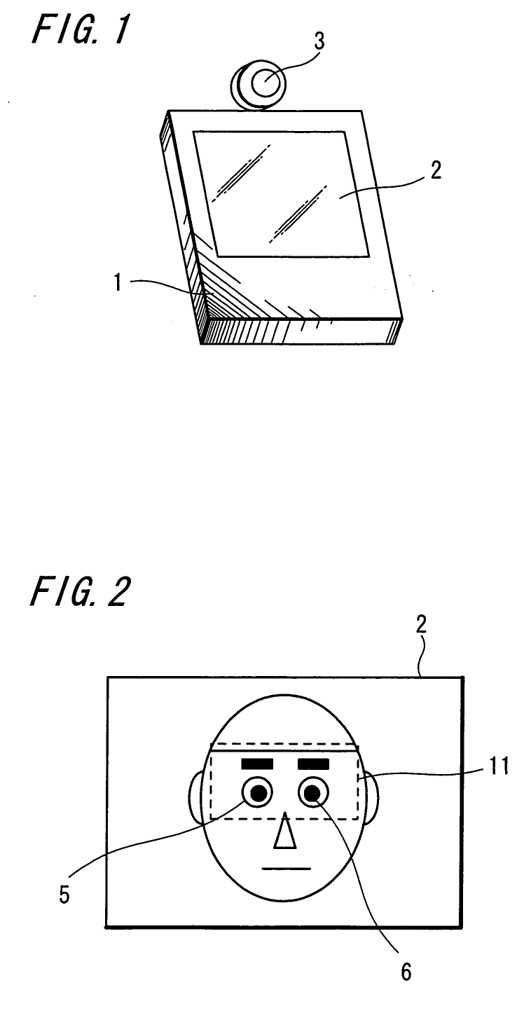

FIG. 2 shows an image of a user picked-up by the camera 3 of a portable terminal 1. In the case of a portable terminal, the attitude of the user when the portable terminal is used by the user is substantially determined, and the user and portable terminal are in mutual opposition at a distance of several tens of centimeters, so that in nearly all cases an image is obtained in which the user's face fits within the screen, as shown in FIG. 2.

This fact is extremely important for the image recognition task, in which the position of the user's eyes is detected. This is because in image recognition, it is most difficult to achieve robustness with respect to the image pick-up environment and image pick-up conditions.

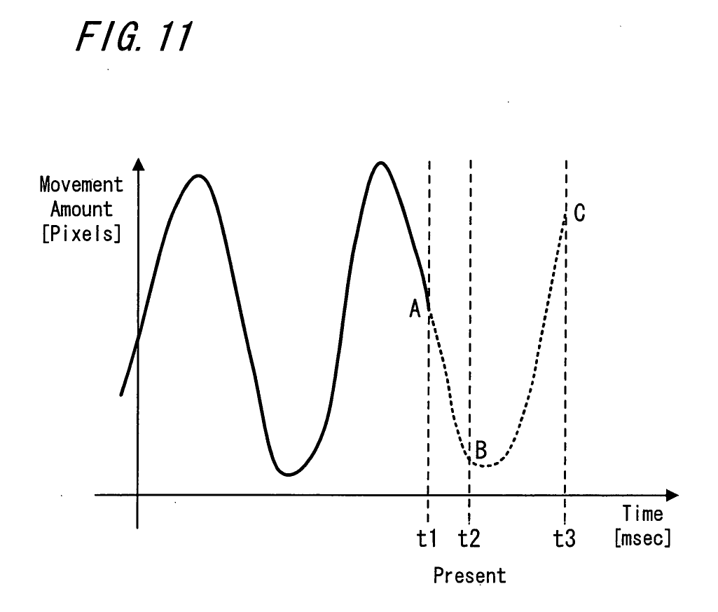

As means for detecting the eyes and irises (pupils) through image recognition, numerous methods have already been proposed, such as the Eigenface method and the method of determining distances and degrees of similarity utilizing partial space methods. Here, however, since realtime processing is necessary, the low-resolution template 12 shown in FIG. 10 is prepared, and matching calculations (to search for maximum correlation values) within a search space 11 of a rectangular region in the center and towards the top of the image are performed, for a low-resolution version of the image such as shown in FIG. 2. By this means, the rough position of the irises 13 is obtained.

Detection of the accurate iris position is performed by executing recursive searches for pixels below a threshold value, taking as the starting point pixels corresponding to the center portions of the template irises 13, and then eliminating fine lines and performing weighting calculations. After performing this operation independently for both eyes, the average coordinates for both eyes are taken to be the representative coordinates of the irises for that frame. The method of detecting the positions of eyes and irises using such a template is itself a well-known method, and is for example described in detail in Japanese Laid-open Patent Application No. 2002-56304 and Japanese Laid-open Patent Application No. 2002-288670.

An appropriate value for the threshold value is determined in advance by generating a histogram of pixels within the search range 11 of the template 12. When the peak value or the average value of the histogram is below a certain value, it is judged that the picked-up image is too dark and that processing to search for the irises is not possible, and subsequent processing is not performed. That is, in the case where iris detection itself is impossible, the method of this invention is not employed.

As described above, the range 11 used for searches in this invention is a fraction of the image pick-up screen, so that the amount of computation processing is greatly reduced. In combination with this, image pick-up sensors manufactured using CMOS technology (CMOS camera ICs) offer important advantages.

In the case of a camera consisting of a CCD element, basically all pixels are read, so that even for search processing using only a portion of the picked-up image, the actual frame rate cannot be increased; whereas in the case of a CMOS camera, block reading in which only an arbitrary area is read is possible, so that a much faster frame rate than usual can be attained.

In this invention, since processing delays exert the most adverse influence on alleviation of image blurring, a faster frame rate through the use of a CMOS camera is an optimal solution. Further, the low power consumption of a CMOS camera is an additional advantage for this invention, in which power is continually supplied to the camera during use.

Next, a process is performed to determine the direction of parallel movement in which the image on the portable terminal is displayed such that the image appears to the user to be stationary, using the result of the user iris search processing.

In this process, the amount of movement of the iris at the time of measurement (the difference between the iris position detected immediately before and the iris position currently detected) may be used to directly calculate the amount of parallel motion of the display image. However, in consideration of the fact that a delay of several tens to several hundreds of milliseconds occurs during processing, a more satisfactory result is obtained if the amount of parallel movement at the time at which the image information is to be displayed is estimated. To this end, it is desirable that estimation be performed using periodic calculations and statistical techniques based on the past amounts of movement of the irises as well as current movement.

That is, as shown in FIG. 11, when the amount of movement of the irises up to a time t₁ in the past is measured at a certain time t₂, rather than taking the latest calculation result A at the current time as the amount of parallel movement of the display image, the amount of parallel movement at the time t₃ at which the image will be displayed on the display device is estimated.

As the estimation algorithm, various algorithms such as the FIR linear estimator, autoregressive moving average method, multiple regression method, exponential smoothing method, Croston method, and similar are known, but no method is stipulated in particular in this invention. The method may be selected as appropriate considering cost and calculation speed.

In broad terms, there are two methods of effecting parallel movement of a displayed image. One is a method in which an image resulting from parallel movement in sub-pixel units of a display image is generated using a digital interpolation filter.

This method is extremely advantageous in terms of cost, and is not accompanied by physical operations, so that durability (low rate of malfunction) is a further advantage. However, in the case of ordinary digital interpolation filters the image is inevitably degraded, so that worsened image quality is a disadvantage.

Prior to illustrating the configuration of such a device, the minimum required configuration of a conventional portable terminal is shown in FIG. 4. Image information from the camera 3 is input as digital data to the CPU 21, and the CPU 21 outputs drawing commands and the image itself to the drawing IC 23. The drawing IC 23 may simply be a driver IC which converts voltages and currents, or may have sophisticated drawing functions like those of the graphics LSI devices of personal computers. The drawing IC 23 directly drives the display device 8 to display the image.

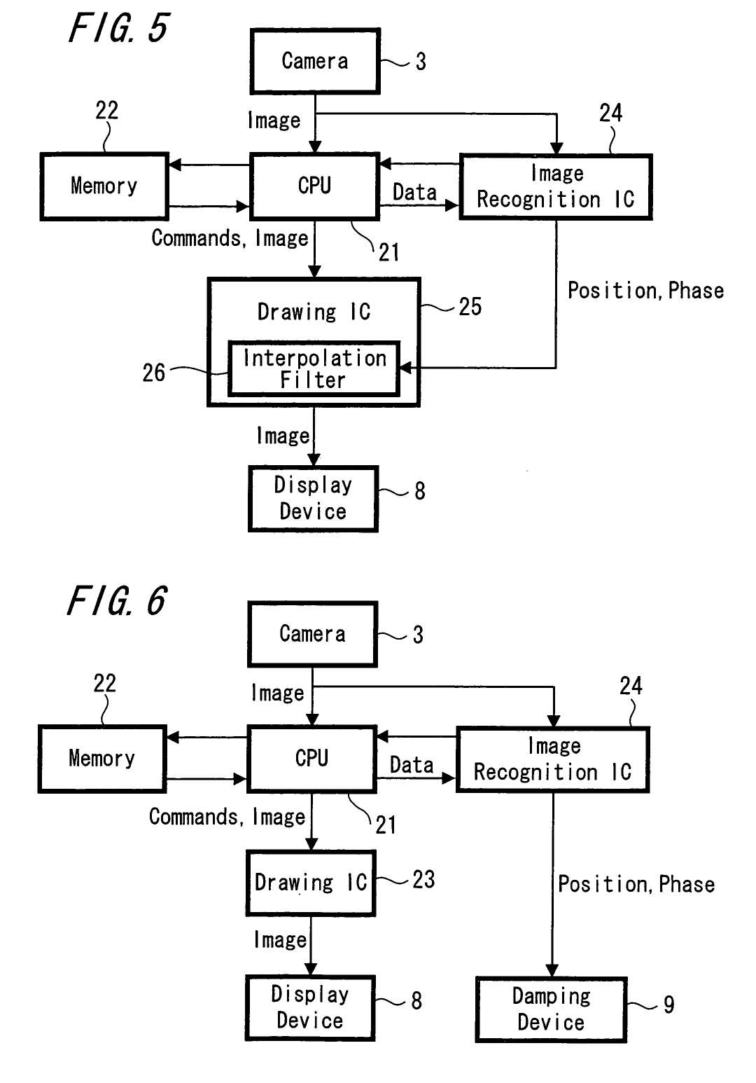

FIG. 5 shows a configuration when a digital interpolation filter is used to realize parallel movement of an image in this invention. An image recognition IC 24 is mounted separately from the CPU 21, and on receiving parallel movement information such as positions and phases output by the image recognition IC 24, the digital interpolation filter 26 provided within the drawing IC 25 handles the actual parallel movement.

The image recognition IC 24 may operate independently, without exchanging data with the CPU 21. However, when processing past data, performing statistical processing of this data, and calculating oscillation periods, it is probably appropriate to consign this portion of the processing to software executed by the CPU 21, which has greater processing ability and versatility.

This may be taken further, so that all processing is performed by the CPU 21 without mounting an image recognition IC 24; however, because the blurring prevention function of this invention must operate constantly, and because rapid response is required despite the complexity of the processing involved, it is appropriate to provide an image recognition IC 24 as dedicated hardware.

When considering demands for reduced power consumption and application in various portable equipment comprising CPUs with different processing capabilities also, a dedicated IC module is preferable. Here it is also preferable, in the interest of more general adoption, that the digital interpolation filter circuit be provided in the image recognition IC rather than in the drawing IC.

FIG. 5 shows a configuration in which the digital interpolation filter is provided in the drawing IC. An image drawn by the drawing IC 25 as a result of a command from the CPU 21 undergoes parallel movement by the digital interpolation filter 26 according to movement information from the image recognition IC 24, and is output to the display device 8. Since the processing desired here is parallel movement processing of the image in sub-pixel units, which are smaller than single pixel units, it is preferable that the digital interpolation filter 26 consists of a polyphase filter.

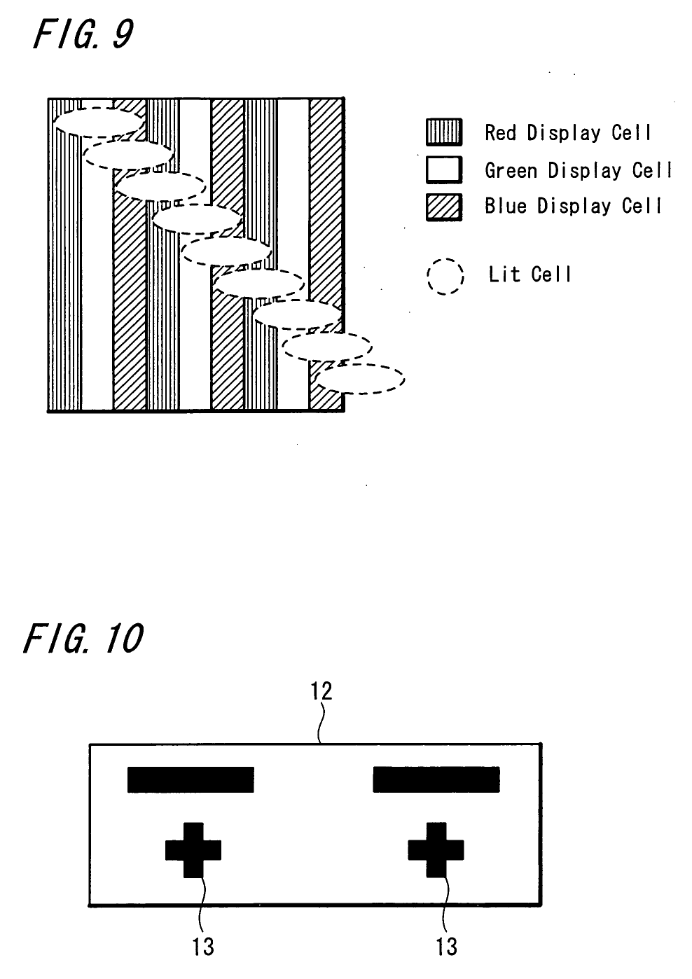

ClearType technology is effective for displaying in a screen the result of digital filtering. This is technology owned by Microsoft Corporation; in a fixed pixel image display device in which red, green, and blue display cells are arranged regularly as in a liquid crystal display, whereas conventionally when an oblique white line is to be displayed cells are lit as shown in FIG. 8, if the cells are instead lit as shown in FIG. 9, there is the advantage that the resolution in the horizontal direction can be effectively increased threefold. Using this technology, parallel-movement display in sub-pixel units becomes smoother.

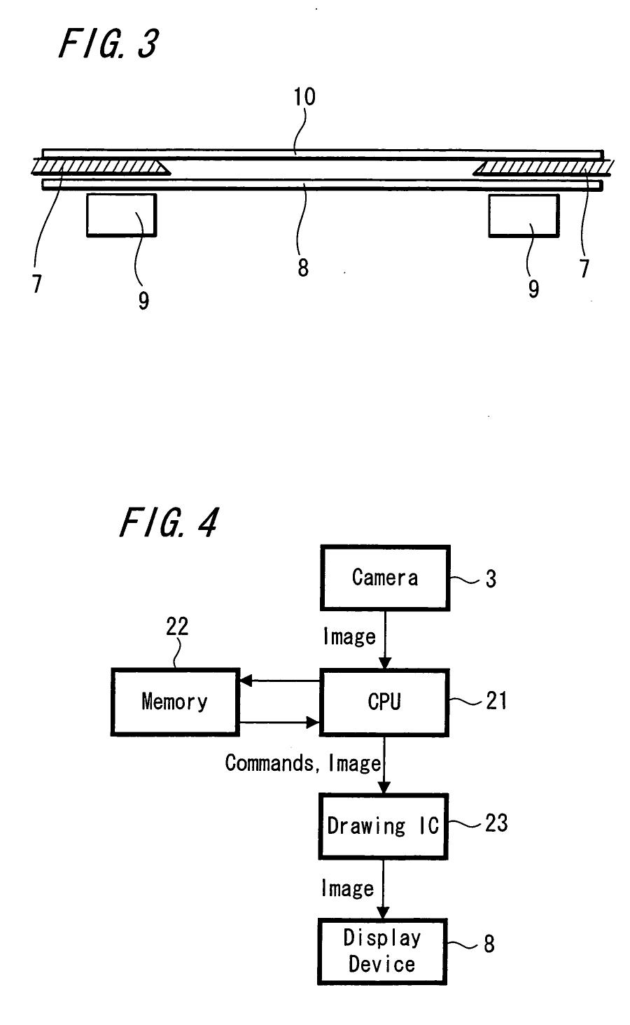

On the other hand, physical parallel movement of display positions is also conceivable as a method of parallel movement of the display image. Specifically, as shown in FIG. 3, a damping device 9 is provided in the image display device 8 consisting of a liquid crystal panel or similar, and by sending signals to this damping device 9, the display device 8 is itself caused to move rapidly in the vertical or horizontal directions (as seen from the front of the portable terminal 1).

The high-speed response and durability of this damping device are extremely important. As the actual damping element within the damping device 9, in addition to a linear motor, electrostatic driving or micromachine utilizing electromagnetic forces, a piezo element, piezoelectric element, oscillating motor, actuator, or similar are conceivable. However, in this invention the nature of the damping element is not essential, and so here no stipulation in particular is made.

The above configuration is shown in FIG. 6. The result of calculation of the parallel movement amount by the image recognition IC 24 is sent directly to the damping device 9. The CPU 21 and display device 8 are no different from the configuration of a conventional portable terminal. If the CPU 21 has high processing capacity, all processing may be performed by the CPU 21 instead of the image recognition IC 24.

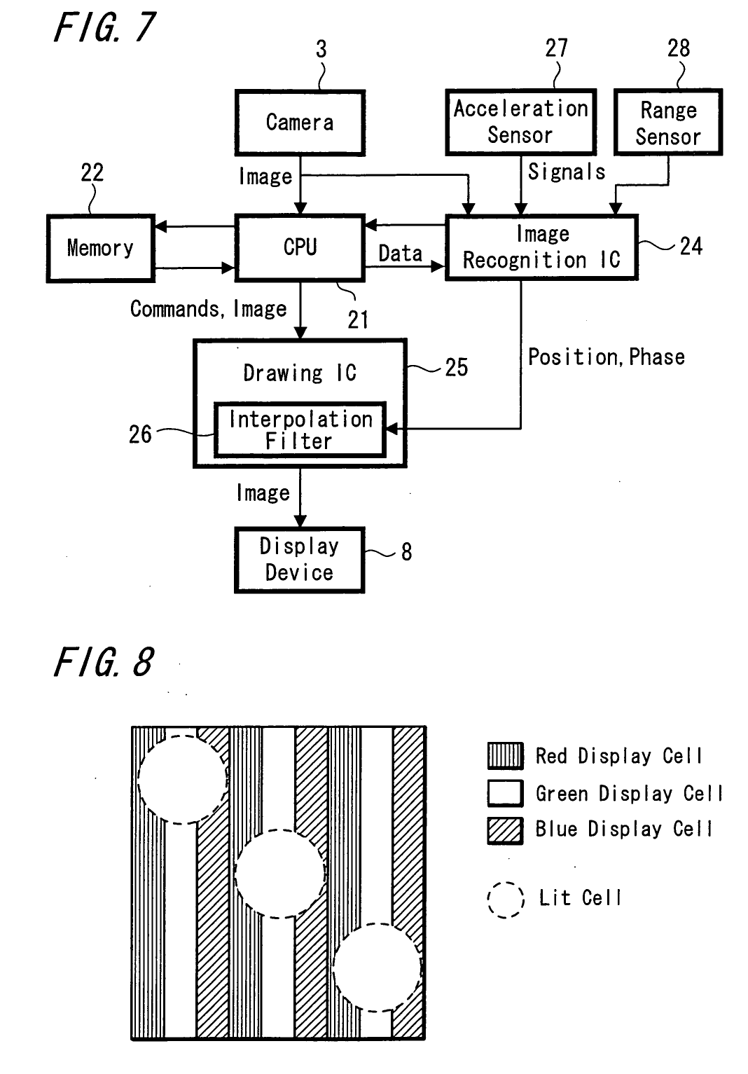

The above explanation assumes a configuration in which only a camera is used as a sensor; however by using another sensor together with a camera, accuracy can be further improved. Candidates for such a sensor include in particular acceleration sensors (including gyroscopes) and range sensors. Such a configuration is shown in FIG. 7. FIG. 7 is an example of parallel movement realized by a digital interpolation filter 26, however these sensors may also be combined with a damping device 9 (FIG. 6).

The acceleration sensor 27 independently detects swaying of the portable terminal 1, and can effect the alleviation of image blurring that is an object of this invention. Advantages compared with a camera are the rapid response speed and higher accuracy. However, because it is not possible to detect oscillations of the user's face, performance is limited. Hence, by for example taking the weighted sum of the iris movement amounts obtained by image recognition from an image picked-up by the camera 3 and the output from the acceleration sensor 27, an acceleration sensor can be used together with the camera 3 in a complementary manner.

The range sensor 28 is used to measure the distance between the portable terminal 1 and the user. The range sensor 28 is also superior to the camera with respect to response speed and accuracy. Computing iris movement amounts alone by image recognition from an image picked-up by the camera 3 enables only detection of parallel movement components of the portable terminal 1 and user, however by using a range sensor 28, the distance in the depth direction between the portable terminal 1 and user is obtained.

Using a range sensor 28, the image can be reduced when the distance decreases and can be enlarged when the distance increases, so that the image always appears to the user to be the same size. This enlargement/reduction processing uses the digital interpolation filter 26. Further, information from the range sensor 28 may be used in image recognition processing, such as for example to detect the positions of the eyes based on fluctuations in the distance between the portable terminal 1 and the user due to protrusions and depressions of the user's face, so that higher accuracy in user recognition can be achieved.

Thus according to the present invention, the display position of an image is altered based on the results of detection of the relative positional relationship between the image display device and the eyes of the user, so that there is the advantageous result that even when the relative positional relationship between the image display device and the user's eyes changes (when the manner of swaying of the user's head does not coincide with the manner of swaying of the image display device), image blurring as seen by the user can be alleviated.

Further, even when the screen of the image display device is viewed from directly behind by a stranger other than the user within a train or similar, so long as the manner of swaying of the head of the stranger does not perfectly coincide with the manner of swaying of the head of the user (so long as the relative positional relationship between the image display device and the eyes of the stranger does not completely coincide with the relative positional relationship between the image display device and the eyes of the user), the displayed image as seen by the stranger appears blurred, so that stealthy viewing of information can be prevented.

Further, by applying this invention to a portable terminal including a camera, the uses and opportunities for use of the camera can be increased, and there is the advantageous result that the camera can be utilized effectively.

Further, when the distance between the image display device and the user's face increases (when the user's head sways backward) the image displayed can be enlarged, and when the distance between the image display device and the user's face decreases (when the user's head sways forward) the image displayed can be reduced, so that there is the advantageous result that even when the distance between the image display device and the user's face changes, the user always sees an image of the same size.

Also, by combining the results of acceleration (oscillation) measurement of the image display device unit by acceleration measurement means to alter the image display position, there is the advantageous result that image blurring can be further alleviated.

Also, by performing detection of the position of the eyes of the user's face by image recognition from an image block-read by a CMOS sensor, there is the advantageous result that the position of the eyes of the user's face can be detected at a high frame rate.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. An image display device, comprising:
image pick-up means;
image display means;
detection means for detecting the position of the eyes of a face by image recognition from an image picked-up by said image pick-up means; and
display position alteration means for altering the position of image display by said image display means, based on the detection result of said detection means.

2. The image display device according to claim 1, wherein
said display position alteration means is a digital interpolation filter which effects parallel movement in sub-pixel units of the display position of the image.

3. The image display device according to claim 2, wherein
said digital interpolation filter estimates the parallel movement amount of the image display position at a point of time in the future that is equal to the delay time resulted from processing by the digital interpolation filter.

4. The image display device according to claim 2 or 3, further comprising:
distance measurement means to measure the distance with an external object, wherein
said digital interpolation filter also performs image enlargement and reduction processing based on the results of measurement of said distance measurement means.

5. The image display device according to claim 1, wherein
said display position alteration means is a damping device which causes physical movement of said image display means.

6. The image display device according to any one of claims 1 through 5, further comprising:
acceleration measurement means for measuring the acceleration of said image display device unit, wherein
said display position alteration means alters the position of image display by said image display means based on the detection results of said detection means and the measurement results of said acceleration measurement means.

7. The image display device according to any of claims 1 through 6, wherein
said image pick-up means is a CMOS sensor.

8. An image blurring prevention method, in an image display device having image pick-up means and image display means, for preventing blurring of the image displayed on said image display means, comprising:
a first step of detecting the position of the eyes of a face by image recognition from an image picked-up by said image pick-up means, and
a step of altering the position of image display by said image display means, based on the detection result of said first step.
